(19) United States
(12) Patent Application Publication
(10) Pub. No.: US 2015/0122629 A1
(43) Pub. Date: May 7, 2015

(54) WET QUENCHING TOWER FOR QUENCHING HOT COKE

(71) Applicants: Bodo Freimuth, Oberhausen (DE); Klaus Freimuth, Oberhausen (DE); Sabine Stebel, Sprockhoevel (DE)

(72) Inventors: Bodo Freimuth, Oberhausen (DE); Klaus Freimuth, Oberhausen (DE); Sabine Stebel, Sprockhoevel (DE)

(73) Assignee: THYSSENKRUPP INDUSTRIAL SOLUTIONS GMBH, Dortmund (DE)

(21) Appl. No.: 14/239,236

(22) PCT Filed: Jul. 19, 2012
(86) PCT No.: PCT/EP2012/064234

§ 371 Date: May 13, 2014

(30) Foreign Application Priority Data
Aug. 17, 2011 (DE) 10 2011 052 785.0

(51) Int. Cl. C10B 39/08; B01D 45/10

(52) U.S. Cl. CPC C10B 39/08; B01D 45/10
USPC 201/39; 202/227

(57) ABSTRACT

A wet quenching tower for quenching hot coke, including a quenching chamber, having a quenching spray device above the quenching chamber for dispensing quenching water, having a flue placed on the quenching chamber, and having at least one separating device which is arranged horizontally or at a slanted angle relative to the vertical, which can be vertically permeated, and which has a plurality of lamellae. Each of the lamellae has a non-branching cross-section, flow paths being formed between each two adjacent lamellae. The flow paths formed between each two lamellae change direction multiple times and correspondingly have a serpentine shape. A method for quenching coke using the aforementioned wet quenching tower is also disclosed.

The invention relates to a wet quenching tower for quenching hot coke, with a quenching chamber, with a quenching shower unit above the quenching chamber for the discharge of quenching water, with a chimney placed onto the quenching chamber and with at least one vertical-throughflow separation device which is arranged horizontally or at an oblique angle to the vertical and which has a multiplicity of lamellae, each with a branch-free cross section, flow paths being formed in each case between two adjacent lamellae.

Wet quenching towers are used for cooling still hot coke directly after the coking process and for avoiding a burn-off of the hot coke. For this purpose, the coke is dumped from the furnace aperture into a quenching trolley and is then brought to the wet quenching tower by means of the quenching trolley. In the wet quenching tower, the hot coke is sprayed with water with the aid of the quenching shower unit, as a result of which a very large quantity of steam is immediately formed which is also designated as quenching vapor. On account of the abrupt cooling and the increase in volume due to the evaporation of the water, large quantities of dust are also generated and are entrained upward together with the quenching vapors.

Both the consumption of water and the emission of dust particles constitute, in practice, decisive factors in terms of wet quenching efficiency and environmental pollution. So that as large a fraction of quenching water as possible can be recovered and thus as large a fraction of dust particles as possible can be separated, throughflow separation devices are arranged in the chimney placed onto the quenching chamber. In this case, it must be remembered that water drops, on the one hand, and dust particles, on the other hand, because of different size distribution and different specific gravity, also have different properties as regards their separability. In order to separate water drops, flow paths are provided which have a change in direction. The water drops, which are heavier than air, cannot follow such a change in direction and are correspondingly deposited on walls of the separation device. By contrast, so that dust particles can also be separated, in the known wet quenching towers special measures are provided which, for example, cause a swirling of the flow at the separation device.

In order to enable dust to be separated, according to DE 2 100 848 C a wet quenching tower with a separation device is known, the separation device having essentially planar lamellae with an end nose.

A wet quenching tower having the features initially described is known from DE 40 11 431 A1. On the basis of a wet quenching tower with a separation device according to DE 2 100 848 C, a configuration of the lamellae in the form of angular profiles is proposed. The combination of angling with an end nose is intended to achieve good separation of both dust and water drops. There is the disadvantage, however, that complete cleaning is difficult particularly in the region of the nose. Furthermore, the separation capacity with regard to water drops also still needs to be improved.

DE 101 138 90 C1 and DE 101 225 31 A1 disclose wet quenching towers which in each case have a plurality of separation devices for improving the separation capacity. Here, too, simply angled lamellae are provided, which have at their ends noses or branches with a T-shaped profile. This shaping of the profile of the lamellae serves for further reducing the immission of solids during the quenching of coke. In order particularly to increase the separation of dust, a turbulent flow is to be generated. In this case, however, there is the disadvantage that the flow resistance is increased greatly by the separation devices, while the turbulence-generating structures are also difficult to clean.

Finally, DE 30 46 313 A1 discloses a wet quenching tower in which the flow passes through the separation device horizontally. The individual lamellae have in cross section a branch in the form of a fin which forms a capture chamber open opposite to the flow direction. Such a shape of the lamellae is unsuitable for vertical-throughflow separation devices, because then, in the region of the branches, cleaning and a removal of deposited dust are possible only with great difficulty.

Against this background, the object on which the invention is based is to specify a wet quenching tower which, while having a simple design, allows an efficient separation of water drops and is easy to clean.

On the basis of a wet quenching tower having the features initially described, the object is achieved, according to the invention, in that the flow paths formed in each case between two lamellae change their direction more than once. The flow paths have a simple serpentine course which is optimized essentially in terms of the separation of water drops.

Whereas, according to the prior art, lamellae which are optimized specially for the separation of dust and are also difficult to clean are always proposed, in the context of the invention a configuration optimized with regard to the separation of water drops is specified, in which the flow paths change their direction at least twice. The lamellae may have a wave shape with curves or with a plurality of successive anglings. Surprisingly, in the context of the invention, the separation device can be operated in such a way that sufficient dust separation is also achieved.

The present invention in this regard allows for the fact that the dust is separated not only directly, but also by being bound in the water drops. So that high immission requirements can be fulfilled in spite of the simplification of the separation device, there is the possibility of sprinkling the quenching vapors rising above the quenching shower unit with a spraying device, in order to achieve a further temperature reduction and therefore increased condensation, an enlargement of drop size and enhanced binding of the dust. When the flow passes through the separation device in a vertical direction, the rising quenching vapors are deflected more than once, that is to say at least twice, while the water drops, because of their inertia, cannot follow the flow unrestricted.

In the theoretical approach, it becomes clear that the drop size is decisive for separation at the lamellae of the separation device. Whereas, in the case of a stipulated deflection, large drops cannot follow the change in direction because of increased inertia, small drops may also be entrained by the rising quenching vapors, without coming up against the surface of a lamella. Improved separation capacity is achieved as a result of the multiple deflection.

Furthermore, it must be remembered that simply angled lamellae described in the prior art result in narrow stipulations with regard to the separation process. By contrast, in the context of the invention, it is possible to adapt the profile of the lamellae to the size distribution of the drops in the quenching vapors. In this regard, both the cross-sectional profile can be varied during the production of the separation device and the size distribution of the drops varied by additional spraying of the quenching vapors, and this cross-section profile and size distribution can be adapted to one another. Optimization of the drop size is also possible during the operation of the wet quenching tower as a result of adapted spraying. Spraying may be controlled, for example, as a function of a direct measurement of the drop size or indirectly from determining the immissions discharged.

According to the invention, the separation device is arranged in such a way that it has a vertical throughflow. In this case, it must be remembered that, without further measures, the liquid separated at the lamellae drops back downward into the rising quenching vapors and may be at least partially entrained again.

In order to allow vertical throughflow, the separation device may be arranged exactly horizontally. Furthermore, it is also possible, however, to arrange the separation device at an oblique angle to the vertical. An oblique arrangement may be utilized, in particular, to allow a lateral discharge of the condensate at the lamellae. For this purpose, the lamellae are expediently set obliquely in such a way as to form along the individual lamellae a gradient, along which the condensate is discharged laterally. In this regard, there is also the possibility of providing the lamellae with structuring which is conducive to lateral discharge in the case of a corresponding oblique setting. Thus, it is possible, in particular, that the flow paths are formed essentially from comparatively large successive curves, while the lamellae have additional fine structuring in order to form channel-like indentations along the lamellae.

In order to allow as simple a production of the lamellae as possible, there is provision, according to a preferred refinement of the invention, whereby the lamellae have along their cross section an essentially uniform thickness. Such lamellae may, for example, be generated readily by the forming of a metal sheet or of a plastic web. Such simple production also makes it possible to arrange the lamellae in the form of bundles in a modular way.

In the context of the invention, branches, that is to say, for example, fin-like branches or T-shaped branches, are dispensed with at the ends. Preferably, also, no sharp bends of the lamellae which demand an increased outlay in manufacturing terms and also more complicated cleaning are provided at the entry cross section and the exit cross section of the flow paths. A refinement is especially preferred in this regard in which, as seen in the flow direction, the ends of the lamellae run out straight or essentially straight. If the flow paths are free of branches, anglings or the like, an approximately uniform width is also achieved along the entire course.

In order to keep the lamellae of the separation device free of dirt and dust accumulations, continuous scavenging or scavenging at intervals is expedient. For this purpose, a scavenging device may be provided, which cleans the separation device from above, from below or from above and from below. For this purpose, the scavenging device may be provided with appropriately oriented spray nozzles. Furthermore, in the case of scavenging at intervals, a control device is to be provided, which is set up for the corresponding interval-like actuation of the spray device. Simplified cleaning is possible due to the simple wave shape or serrated shape of the lamellae which is preferred in the context of the invention. In particular, the lamella may be shaped in such a way that their entire surface is accessible to a corresponding water film during cleaning.

The subject of the invention is also a method for quenching coke by means of the above-described wet quenching tower, hot coke being delivered to the quenching chamber from a coke furnace, for example by means of a quenching trolley, the hot coke being cooled with quenching water, so as to form quenching vapors which contain steam and dust particles, the quenching vapors which rise in the chimney being routed through the separation device, water drops with dust bound therein being separated in the separation device as a result of multiple deflection along the flow paths, and the separation device being cleaned continuously or at intervals by means of the scavenging device.

Usually, the rising quenching vapors are additionally sprayed with water above the quenching shower unit and before the at least one separation device is reached, in order to achieve an increase in the average drop size, cooling of the quenching vapors and therefore an increase in condensation and also additional binding of dust particles in the quenching vapors. In particular, spraying may take place in such a way that narrow stipulations with regard to particle emission are adhered to.

In the context of the invention, it is possible, in particular, that a laminar flow is generated in the flow paths between the lamellae. In the case of a laminar flow, especially low flow resistances arise overall, and the correspondingly simply shaped lamellae can also be cleaned especially easily by the scavenging device. In particular, the lamellae may be shaped in such a way that complete wetting with the scavenging water is possible during cleaning by the scavenging device.

In the context of the invention, the wet quenching tower may basically also have at least one additional separation device which expediently also has lamellae which form flow paths with a plurality of changes in direction.

The invention is explained below by means of a drawing which illustrates only one exemplary embodiment and in which, diagrammatically,

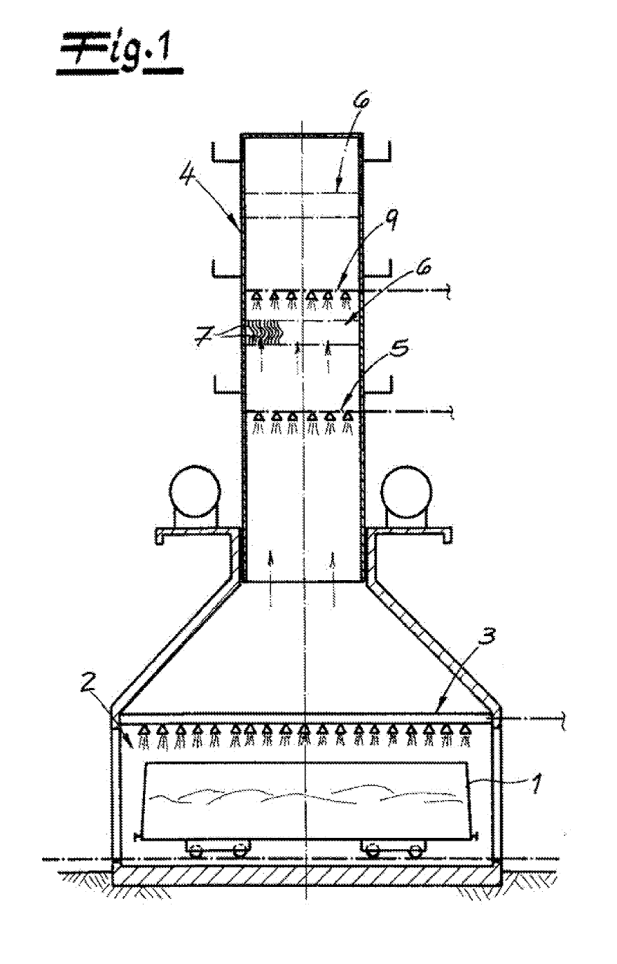

FIG. 1 shows a wet quenching tower in vertical section,

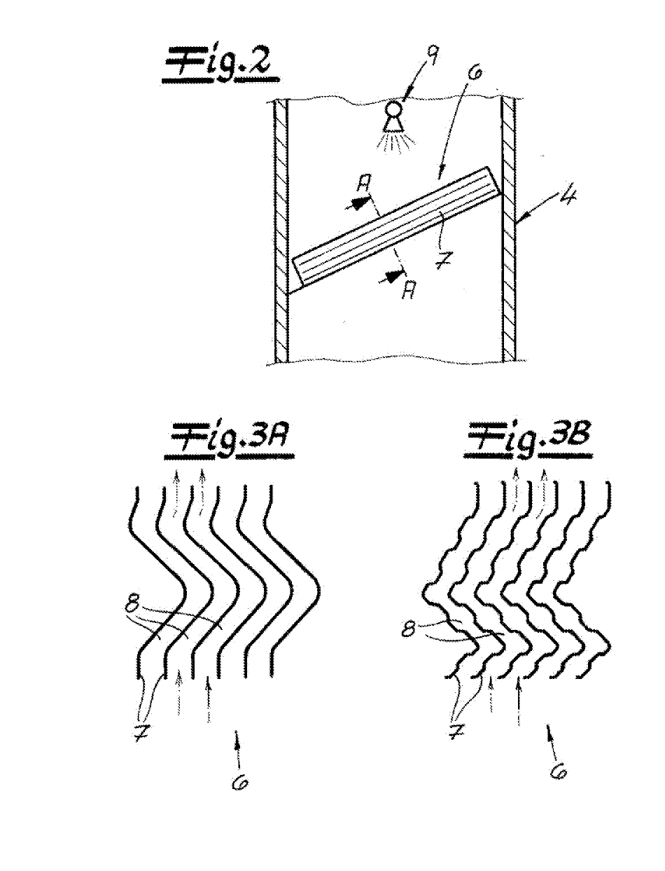

FIG. 2 shows a detail of a chimney, illustrated in FIG. 1, of the wet quenching tower in a side view rotated through 90°,

FIG. 3a and FIG. 3b show profiles of lamellae of a separation device of the wet quenching tower in a section along the line A-A of FIG. 2.

FIG. 1 shows a wet quenching tower for quenching hot coke which, in the exemplary embodiment, is introduced into a quenching chamber 2 by means of a quenching trolley 1. In order to cool the hot coke and avoid burn-off, the coke received in the quenching trolley 1 is sprayed with water by a quenching shower unit 3, with the result that quenching vapors are formed which contain steam and dust particles. A chimney 4, in which the quenching vapors rise upward, is placed above the quenching chamber 2.

Inside the chimney 4, starting from the quenching chamber 2, above the quenching shower unit 3 a spraying device 5 is provided, by means of which the rising quenching vapors are additionally sprayed with quenching water. This spraying device serves for cooling the quenching vapors further and consequently for achieving increased condensation. In this regard, the average drop size is also increased, and therefore separation becomes easier in a separation device 6 which follows in the flow direction, that is to say is arranged above. Finally, additional dust particles from the quenching vapors are also bound in liquid drops as a result of the additional spraying by means of the spraying device 5. The dust particles are therefore to some extent washed out of the quenching vapors by means of the spraying device.

The separation device 6 is designed for vertical throughflow and is tilted slightly with respect to the horizontal plane. The exact orientation of the separation device 6 may be gathered from a comparative look at FIG. 1 and FIG. 2, FIG. 2 showing a view rotated through 90° with respect to FIG. 1.

It can already be seen from FIG. 1 that the separation device 6 comprises a multiplicity of parallel lamellae 7, the lamellae 7 having in each case a branch-free cross section, and flow paths 8 being formed in each case between two adjacent lamellae 7.

According to FIG. 2, in the exemplary embodiment the separation device 6 is tilted with respect to a horizontal plane in such a way that the individual lamellae 7 have along their longitudinal extent a lateral gradient which may amount, for example, to between 15° and 45°.

The shape of the lamellae 7 is illustrated by way of example in FIGS. 3a and 3b. According to the invention, the direction of the flow paths 8 formed in each case between two lamellae 7 changes more than once, according to FIG. 3a the lamellae 7 having in cross section a wave shape with at least two turning points. As a result of multiple deflection, the separation capacity is increased in respect of drops which cannot follow the changes in direction because of their inertia. Furthermore, it can be gathered identically from FIGS. 3a and 3b that the flow paths 8 have along their course, in the vertical direction, an approximately uniform cross section, that is to say an approximately uniform spacing between the lamellae 7.

Moreover, it can be seen that, according to the two exemplary embodiments of FIGS. 3a and 3b, the lamellae 7 have a uniform thickness along their cross section. The lamellae 7 illustrated can consequently be produced especially simply by the forming of a metal sheet or of a plastic web. Even if the lamellae are formed by injection molding, the contour illustrated can be produced especially simply and therefore cost-effectively.

The separation capacity in the separation device 6 depends essentially upon the size distribution of the drops. This size distribution can be to some extent set by the additional spraying by means of the spraying device 5. In particular, the shape of the lamellae 7 which is actually selected, that is to say the exact profile of the lamellae 7 and the spacing between the lamellae 7, can also be optimized as a function of the drop size to be expected.

According to FIG. 1, above the separation device, a scavenging device 9 is provided, by means of which the lamellae 7 of the separation device 6 can be cleaned.

Additionally or alternatively, a scavenging device may also be provided below the separation device 6. On account of the simple shape of the lamellae 7 which is illustrated in FIGS. 3a and 3b, these can also be cleaned especially efficiently by means of the scavenging device 9. In particular, complete wetting of the lamellae 7 and therefore reliable cleaning can be achieved.

The lamellae 7 are shaped in such a way that a laminar or essentially laminar flow is achieved as a function of the flow velocities.

Surprisingly, efficient separation of dust particles is also possible by means of the shape of lamellae 7 which is optimized per se for the separation of drops. For this purpose, use may be made of the fact that, by means of the additional spraying by the spraying device 5, large parts of the dust are bound in water drops, these water drops then being separated very efficiently. In contrast to the prior art, the dust is bound in water drops to an increased extent by the separation device 7 and is separated directly to a lesser degree.

Finally, it is indicated in FIG. 1 that a further separation device may be arranged further above, in which case this merely indicated separation device 6 is also preferably configured as described above.

1. A wet quenching tower for quenching hot coke, with a quenching chamber (2), with a quenching shower unit (3) above the quenching chamber (2) for the discharge of quenching water, with a chimney (4) placed onto the quenching chamber (2), and with at least one vertical-throughflow separation device (6) which is arranged horizontally or at an oblique angle to the vertical and which has a multiplicity of lamellae (7), each with a branch-free cross section, flow paths (8) being formed in each case between two adjacent lamellae (7), characterized in that the flow paths (8) formed in each case between two lamellae (7) change their direction more than once.

2. The wet quenching tower as claimed in claim 1, characterized in that the flow paths (8) have an approximately uniform width along their course.

3. The wet quenching tower as claimed in claim 1 or 2, characterized in that the lamellae (7) have in cross section a wave shape with at least two turning points.

4. The wet quenching tower as claimed in one of claims 1 to 3, characterized in that the lamellae (7) have an essentially uniform thickness along their cross section.

5. The wet quenching tower as claimed in one of claims 1 to 4, characterized by a spraying device (5) arranged above the quenching shower unit (3).

6. The wet quenching tower as claimed in one of claims 1 to 5, characterized by a scavenging device (9) for cleaning the separation device (6).

7. The wet quenching tower as claimed in claim 6, characterized by a control device which is set up for actuating the scavenging device (9) at intervals.

8. A method for quenching coke by means of a wet quenching tower as claimed in claim 6 or 7, hot coke being delivered to the quenching chamber (2) from a coke furnace,
the hot coke being cooled with quenching water, so as to form quenching vapors which contain steam and dust particles,
the quenching vapors which rise in the chimney (4) being routed through the separation device (6),
water drops with dust bound therein being separated in the separation device (6) as a result of multiple deflection along the flow paths (8), and
the separation device (6) being cleaned continuously or at intervals by means of the scavenging device (9).

9. The method as claimed in claim 8, a laminar flow being generated in the flow paths (8) between the lamellae (7).

10. The method as claimed in claim 8 or 9, characterized in that the lamellae (7) are wetted completely with scavenging water during cleaning by means of the scavenging device (9).

11. The method as claimed in one of claims 8 to 10, characterized in that the rising quenching vapors are additionally sprayed with water above the quenching shower unit (3) and before the at least one separation device (6) is reached.
